(19) United States
(12) Patent Application Publication
(10) Pub. No.: US 2010/0172576 A1
(43) Pub. Date: Jul. 8, 2010

(54) Color Analyzer And Calibration Tool

(76) Inventors: Ilia Goldfarb, Fredricton (CA); Irina Kondratova, Fredricton (CA)

Correspondence Address: PERLEY-ROBERTSON, HILL & MCDOUGALL LLP, 1400-340 Albert Street, OTTAWA, ON, K1R 0A5, CA

(21) Appl. No.: 12/499,872

(22) Filed: Jul. 9, 2009

Related U.S. Application Data
(60) Provisional application No. 61/079,973, filed on Jul. 11, 2008.

(51) Int. Cl. G06K 9/34

(52) U.S. Cl. 382/164

(57) ABSTRACT

A color analysis tool employs color segmentation based on HSB values in an image to determine a distribution of the colors used in a source such as a set of webpages or a medical image. The source can be converted to an image that is then segmented by color and analyzed to determine the color distribution so that a graphical representation of the distribution can be created. A user can adjust the segmentation process to use user determined boundaries in the segmentation process.

### RELATED APPLICATION

This application claims priority to U.S. application Ser. No. 61/079,973 filed on Jul. 11, 2008, the contents of which are hereby incorporated by reference in its entirety.

### FIELD OF THE INVENTION

This invention relates generally to color analysis, and more particularly relates to analysis of color usage in an image.

### BACKGROUND OF THE INVENTION

In many fields, the manner in which color affects reader comprehension and receptiveness is of great interest. Marketing campaigns rely on the selection of an appropriate color scheme to avoid viewers being either distracted or repulsed by the selection of colors. Products offered in different geographic regions are often localized so that they are more familiar and accessible to a local audience, and the selection of color is an important factor in this process.

To many viewers, color imparts meanings to messages. Many of these imparted meanings have cultural significances that are not apparent to outsiders. Furthermore, in one cultural group there may be little differentiation between similar shades while in another culture, the similar shades are seen as distinct.

The difficulty in quantitatively analyzing color limits the information available to individuals or groups seeking to employ such data in designs for products and campaigns. It is, therefore, desirable to provide a color analysis tool that allows for quantitative assessment of the colors employed in a series of images and web pages.

Additionally, medical image color analysis can assist medical practitioners in identifying certain disease or a progression of the decease. Color image analysis is used in numerous applications, including, diagnostic pathology (tissue-based diagnostics), as well as diagnostic imaging in endoscopic and dermatological applications.

Virtual pathology is the process of assessing digital images of histological slides. It is becoming increasingly important in today's medical laboratory environment. Digital image acquisition systems for virtual pathology applications are becoming widespread, and associated image analysis solutions are considered to be the next critical step in automated histological analysis. For example, a tissue microarray with known disease stages can be used to enable pathology slide image analysis, and prostate cancer could be diagnosed by histopathology interpretation of stained tissue sections. Other examples of possible color image analysis applications include color analysis for gastric cancer based on the images from gastroscopy examination and color-based analysis for diagnostics of cervical cancer based on color change of cervix tissues when exposed to acetic acid. Toxicology-based image analysis solutions are also steadily increasing in popularity, especially within the pharmaceutical industry.

### SUMMARY OF THE INVENTION

In accordance with one aspect of the present invention there is provided a method of analyzing color distribution in at least one image, comprising: rendering said at least one image to generate an input image having at least one pixel; and segmenting said at least one input image to a fixed category or a color category and subcategory, based on an HSB triplet value of said at least one pixel.

In one aspect of the method of the present invention said method further comprises determining a distribution of said segmented at least one pixel in said fixed category or said color category and subcategory.

In one aspect of the method of the present invention said segmentation further comprises converting said at least one pixel to said HSB triplet value.

In one aspect of the method of the present invention said segmentation comprises locating said HSB triplet value in a color lookup table.

In one aspect of the method of the present invention said at least one image is a web browser image or medical image.

In one aspect of the method of the present invention the dimensions of said at least one image are defined as a pixel window.

In one aspect of the method of the present invention said rendering of said at least one image is carried out using an HTML rendering engine.

In one aspect of the method of the present invention said input image is a TIFF file, a JPEG file, a bitmap file or an input file.

In one aspect of the method of the present invention, said method further comprises adjusting the boundaries of said fixed category or said color category and subcategory. In a specific example, said boundaries are set numerically or graphically.

In accordance with another aspect of the present invention, there is provided a system for analyzing color distribution in at least one image, comprising: a processor; memory; computer instructions stored in memory and executable by the processor for performing the functions of: rendering said at least one image to generate an input image having at least one pixel; and segmenting said at least one input image to a fixed category or a color category and subcategory, based on an HSB triplet value of said at least one pixel.

In one aspect of the present invention said system further comprises determining a distribution of said segmented at least one pixel in said fixed category or said color category and subcategory.

In one aspect of the system of the present invention said segmentation further comprises converting said at least one pixel to said HSB triplet value.

In one aspect of the system of the present invention said segmentation comprises locating said HSB triplet value in a color lookup table.

In one aspect of the system of the present invention said least one image is a web browser image or medical image.

In one aspect of the system of the present invention dimensions of said at least one image are defined as a pixel window.

In one aspect of the system of the present invention said rendering of said at least one image is carried out using an HTML rendering engine.

In one aspect of the system of the present invention said input image is a TIFF file, a JPEG file, a bitmap file or an input file.

In one aspect of the system of the present invention further comprises adjusting the boundaries of said fixed category or said color category and subcategory.

In one aspect of the system of the present invention said boundaries are set numerically or graphically.

In another aspect of the present invention there is provided a computer readable recording medium having recorded thereon a program for executing the method as described herein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached figures, wherein:

FIG. 1 is a flowchart illustrating a color segmentation process;

FIG. 2 illustrates a sub-categorization color map;

FIG. 3 illustrates a graphical representation of the color usage of a set of sample inputs to the present invention;

FIG. 4 illustrates a side-by-side comparison of a color segmented image to the original image;

FIG. 5 illustrates an interface to a calibration tool;

FIG. 6 illustrates an embodiment of the present invention in conjunction with other systems;

FIG. 7 is a flowchart illustrating an exemplary embodiment of the present invention;

FIG. 8 is a block diagram illustrating a functional block representation of an embodiment of the present invention; and

FIG. 9 illustrates a further side-by-side comparison of a color segmented image to the original image.

The numbers in bold face type serve to identify the component parts that are described and referred to in relation to the drawing depicting various embodiments of the present invention. It should be noted that in describing various embodiments of the present invention, the same numerals have been used to identify the same or similar elements. Moreover, for the sake of simplicity, parts have been omitted from some figures of the drawings.

### DETAILED DESCRIPTION

As will be discussed in more detail below, the present invention is directed to a system and method for the analysis of color in a design such as an image, an overall webpage, a medical image, and the like.

Image(s)

Web Page(s)

To address issues involving the determination of cultural cues in color selection, and to allow analysis of color selection for a number of scenarios, the present invention provides a system and method for analyzing color use and distribution on a webpage. By performing the analysis operation on a plurality of websites, it is possible to derive a distribution that shows how color is employed across the selected websites. The websites can be selected for their appeal to a particular identified group of users. To build the set of websites, various approaches can be employed without departing from the scope of the present invention. The user can specify a set of URLs which can either form a closed set of sites, or they can serves as a starting point from which links can be followed either to a predetermined depth or the links can be followed so long as they remain in a specified domain. Alternatively, the set can be generated by an external tool that forms a group of sites related to each other on the basis of geography, allowing the analysis of websites popular to users from a geographic region, or any other demographic information, such as age, income and gender, that is available and can be used to select a set of websites popular with the identified group. Websites relevant to a particular topic can also be grouped together for such an analysis.

Determining the distribution of colors on a webpage, or a series of webpages, presents a number of different problems. Color information contained in the hyper-text markup language (HTML) codes of a webpage is provided as a tag that specifies a color defined in a palette. These tags can be used to define the color of any HTML element such as background color or the color of text. However, a programmatic analysis of this color information is often insufficient and yields inaccurate information as it is rare that a webpage contains only simple HTML elements. Instead, most webpages include graphics and other embedded elements including interactive elements such as Adobe™ Flash™ elements. Colors graphics and interactive elements cannot be accounted for in a simple programmatic parsing of the HTML. As an example of why a programmatic parsing fails to work properly, consider a webpage which defines black as its background color and white as its foreground text color. Based on the amount of text and the size of the text, a ratio of the two colors can be computed by looking at the HTML. This analysis will be invalid if the HTML also specifies a background image that is tiled over the black background, and has other elements that are overlayed atop the page. If the non-HTML elements employ transparent regions, the problem is further magnified as an HTML based parsing cannot simply be coupled to a graphic analysis.

Medical Image(s)

Medical image analysis is normally done on the basis of color segmentation. In this context, color segmentation refers to partitioning of an image into different regions that are homogeneous with respect to some image feature. Color image segmentation is usually the first task of any image analysis process. All subsequent tasks, such as feature extraction, rely heavily on the quality of segmentation. Without a good segmentation algorithm, a particular feature may never be recognizable.

Known methods of image segmentation include thresholding and region merging. They are used in the EM Gaussian method (k-means algorithm) that is often employed in medical image analysis (for example, they could be used in diagnosis for prostate cancer by histopathology interpretation of stained tissue sections).

The number of clusters k is an input parameter for the above mentioned method of segmentation. A known drawback of the k-means algorithm is that an inappropriate choice of k may easily yield poor results. The identification of the appropriate k value is highly laborious and dependent on the advanced mathematical knowledge and on a particular application (for medical image analysis, it is highly dependable on particulates of a disease and images features). Thus, the choice of an appropriate k value is commonly done by a highly skilled imaging professional and not by the end user (e.g. medical practitioner).

To address the noted issues of medical image analysis, the present invention provides a system and method for analyzing color use and distribution on a medical image that is based on user-defined color segmentation.

Image Analysis

Web Page(s)

In accordance with one embodiment of the system and method(s) of the present invention, these issues are addressed using an HTML rendering engine that renders the web page image to either a stored graphic file (preferably using a standard file format such as Tagged Image File Format (TIFF), Joint Photographic Experts Group (JPEG), or a bitmap file) or to an input of a graphic analysis engine. Standard HTML rendering engines can be used in this rendering process, but instead of directing their output to a user display, the output is directed to a file or to the input. By rendering a page prior to analysis, the present invention obviates the need to combine two different analysis engines, and can simply rely upon a graphics analysis.

The rendering process can accept a preference, which can be user defined, to specify the dimensions of the web browser window that would conventionally be used to view the page. A browser that is very wide may show all the text in the central column (depending on the layout of the page), and thus would include more of the background colors in the ratio. Similarly, if a page is designed for horizontal viewing, a tall window would introduce extra background areas. By permitting the user to specify a browser size in pixels (i.e., define a pixel window), the user is afforded the opportunity to control how the viewed pages would be rendered based on common screen and web browser sizes.

Depending on the color space and available color palette, a reasonably sized collection of pages will introduce another problem addressed by the present invention, that of having too many unique colors defined to provide the user with meaningful information. When presenting color usage information to a user, there is a practical limit on the number of colors that information can be provided for. If too many colors are referred to, the user will be overwhelmed by the information and will be unable to identify a reasonable color distribution. If the information is presented in a graphical fashion, such as in a pie chart, having too many colors will result in pie chart wedges that are too small for a user to identify. With a sufficiently large and diverse set of pages, such a graphical representation of the color distribution becomes increasingly more difficult to interpret due to the increasing number of colors. When pages include graphical elements the number of colors on a single page quickly becomes unmanageable due to the number of unique colors used in simple transitions between colors.

To address this issue, the analysis of the rendered page can be preceded by a color segmentation process to reduce the number of colors in the image to an acceptable palette size. This process can be performed using color clustering which allows each color to be mapped to the closest color in the selected palette, thus reducing the number of colors in the analysis.

Rendered images often employ an RGB color model to specify the component red, green and blue values for a given color. This model is often employed due to the additive color nature of common displays. Although RGB and CMYK color models are preferred for specifying colors in production environments, they are often difficult for users to conceptualize. However, specifying a triplet based on the hue saturation and brightness (HSB) model (or the equivalent HSV model) is often more intuitive to users. Additionally, the HSB model effectively pre-groups colors to a certain degree based on the hue of the specific color. As such, in the color segmentation process, the first step is to convert the input image (the image generated from the rendering of the webpage) to an HSB color model showing the colors as an HSB color triplet. This step can be skipped if the image is already provided as an HSB file.

The hue value in the HSB triplet defines a set of similar colors. In the present invention, the hue values are grouped together, so that all pixels within a defined range of colors are specified as being in the same color category. The saturation and brightness values are used to assign a sub-category, or a fixed color category. This process results in assigning a color to a category (either fixed or color) and a sub-category where appropriate.

Fixed categories are used to refer to white, gray and black values. In the HSB model, regardless of the hue, if there is a sufficiently low brightness level, the color appears to be black, or black with a slight tinge of color to users. Accordingly, where the brightness level is sufficiently low, the color is mapped to the fixed category of black. If there is sufficiently high brightness, with sufficiently low saturation, the color appears to be either white, or white with a slight tinge of color to users. Accordingly where the brightness is sufficiently high, and the saturation is sufficiently low, the color is mapped to the fixed category of white. If the saturation is sufficiently low, and the brightness is neither too high or too low to be either black or white, the color appears to be a shade of gray, or possibly a color tinged gray. A number of fixed categories of gray can be defined, and the colors can be assigned to the appropriate shade of gray in accordance with the relevant brightness value.

If the color is not assigned to one of the fixed categories, it will be assigned to one of the color categories based on the hue value. A sub category can then be selected based on the combination of S and B values.

When the color is assigned to the relevant category (and sub-category where appropriate) the next color in the image can be selected and the process repeated until all the image colors have been assigned. One skilled in the art will appreciate that it is possible to parallelize the decision process to allow multiple decisions to be made simultaneously.

Images that have been converted to color categories can be stored using the new color categories, or a count of the color categories can be performed. The color category count can be performed in the categorization process through the use of running totals if so desired. If a categorized color image is being stored, the process of assigning colors can be performed on a pixel by pixel basis replacing each pixel's HSB value with a reference to the category and sub category determined in the segmentation process, or the HSB value of the pixel can be overwritten with a representative HSB value selected in accordance with the determined category and sub-category Both approaches have benefits as will be discussed below with respect to the figures.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

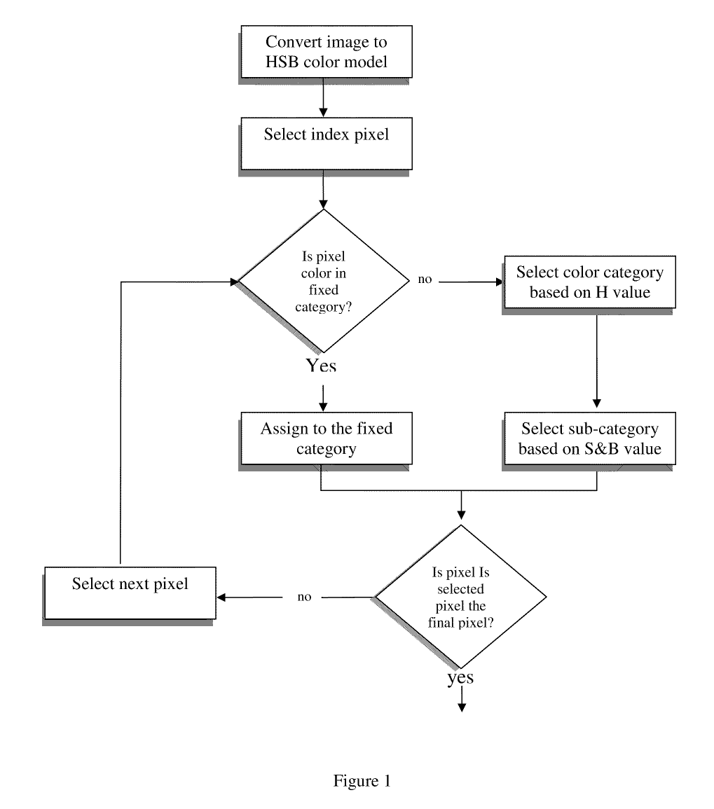

FIG. 1 is a flowchart illustrating the above described process. After an optional conversion to HSB values, an index pixel in the image is selected. A determination is made, based on the HSB value of the pixel, of whether the pixel belongs to a fixed category. If the pixel belongs to a fixed category, it is assigned to the fixed category. If the pixel does not belong to the fixed category, a color category is selected based on the H value, and a relevant sub category is selected in accordance with the S and B values of the HSB triplet. At this point, both branches of the decision process feed to a decision on whether the selected pixel is the final pixel in the image. If the pixel is the final pixel, the process terminates. If the pixel is not the final pixel, the next pixel is selected and the process return to the decision of whether the selected pixel belongs to a fixed category.

One skilled in the art will appreciate that if the image is to be saved using the new colors, the step of assigning a fixed category, or the step of assigning a sub-category can include rewriting the pixel value with an HSB triplet indicative of the category and sub-category. If the image is not saved using the new colors, the count corresponding to the assigned category and sub-category can be incremented at each relevant decision point.

The number of categories and sub-categories can vary between implementations without departing from the scope of the present invention. In one presently preferred embodiment of the present invention, there are five fixed categories (white, light gray, gray, dark gray and black), twelve color categories as described in table 1 below with exemplary values for appropriate hue ranges, and four sub-categories (light, medium, dark and shaded).

TABLE 1

| # | Name | Hue Range |
|---|---|---|
| 1 | Orange | 13-30 |
| 2 | Yellow Orange | 31-43 |
| 3 | Yellow | 44-66 |
| 4 | Yellow Green | 67-82 |
| 5 | Green | 83-168 |
| 6 | Blue Green | 169-190 |
| 7 | Blue | 191-256 |
| 8 | Blue Violet | 257-265 |
| 9 | Violet | 266-293 |
| 10 | Red Violet | 294-328 |
| 11 | Red | 329-355 |
| 12 | Red Orange | 356-360, 0-12 |

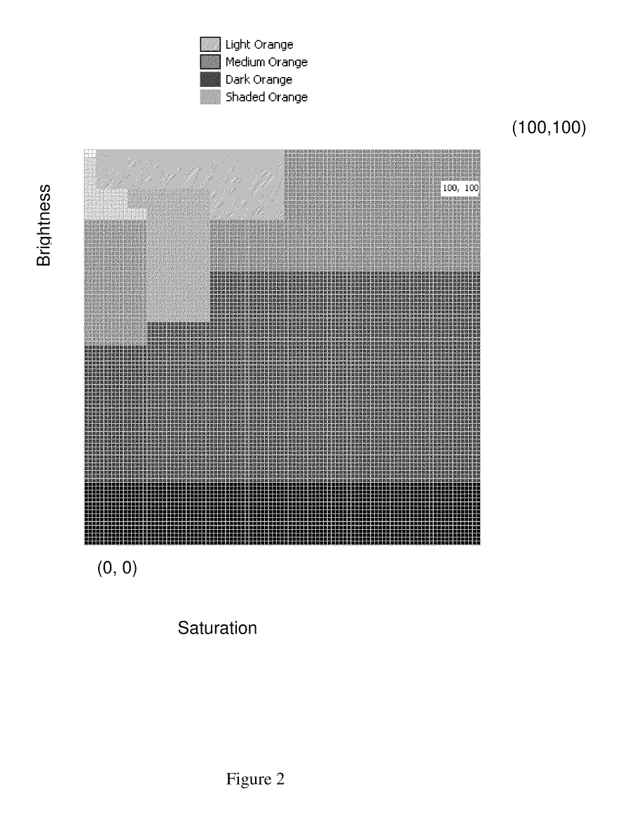

A color map, as illustrated in FIG. 2, can be used to classify a color into the appropriate sub-category. For a given hue, or category, the brightness and saturation define the sub-category. The map can be represented as a grid with brightness and saturation on respective axes. If the S and B values each run from 0 to 100, the color map is a 101×101 array. Various sections on the map correspond to different sub-categories. As indicated, on the color map, if the brightness is sufficiently low it is treated as black, and if the saturation is sufficiently low, it is either a gray or a white. If the determination of whether or not the selected pixel is in one of the fixed categories has already been made, the only options remaining are the light, medium, dark and shaded sub-categories. The boundaries between the regions can be varied in different embodiments to suit the particular needs of the user.

One skilled in the art will appreciate that each HSB value is mapped to a category and sub-category in a repeatable fashion. Accordingly, it is possible to implement the above described flowchart using a look-up table generated by the boundaries defined in the combination of the color map and the hue region assignments. Use of such a lookup table is considered to be the equivalent of the per pixel decision process for the purposes of the present invention.

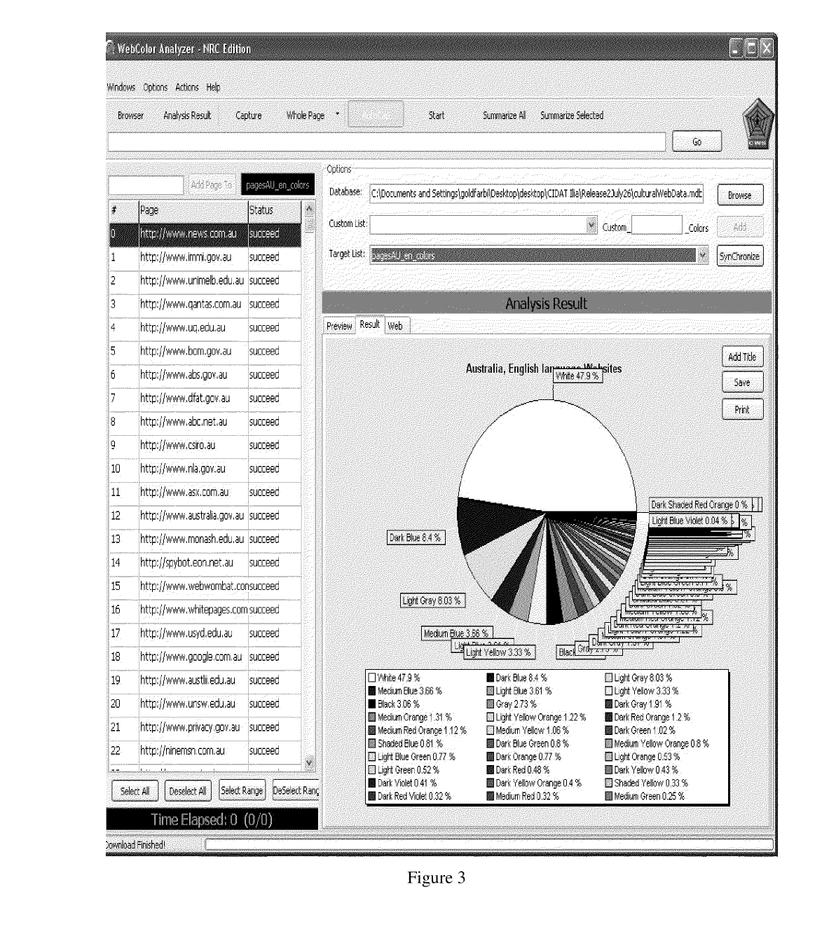

After the colors of an image have been classified the number of pixels corresponding to each classified category and sub-category can be calculated (as noted above, this calculation can be performed during the categorization process). Using these results, a pie chart can be obtained to show the results to the user as a friendly presentation format. The pie chart illustrates the proportion of a page that corresponds to each color segment as illustrated in FIG. 3.

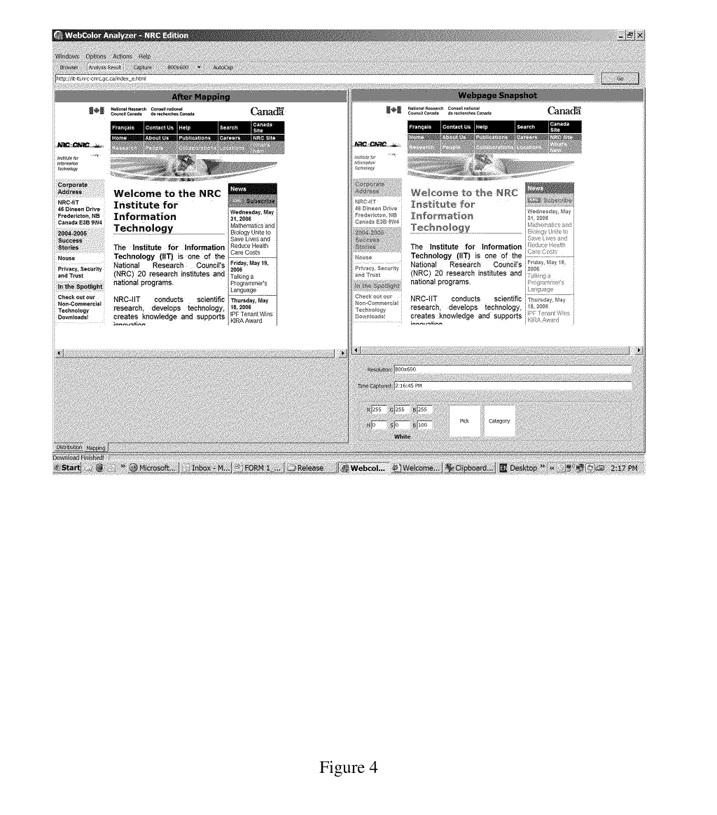

As noted above, images can be saved using the new color categories. This allows a user to view the input image (unadjusted) with the output of the segmentation process (adjusted) as illustrated in FIG. 4. The user can then determine if the boundaries set in the categorization process are appropriate for the analysis. One skilled in the art will appreciate that in certain groupings of websites, the color palette can be limited to a small selection of similar hues. For example, a collection of sites may use very little blue and green, but rely heavily on oranges and reds. The default hue separation shown in Table 1, would then be inappropriate as it would not provide sufficient granularity in the oranges and reds, while providing an overly fine segmentation of colors that are not used. This is easily apparent from a view of the before and after images shown in FIG. 4 and after viewing the pie chart of FIG. 3. Similarly, where a small selection of colors is employed, the default boundaries on the color map may not be appropriate.

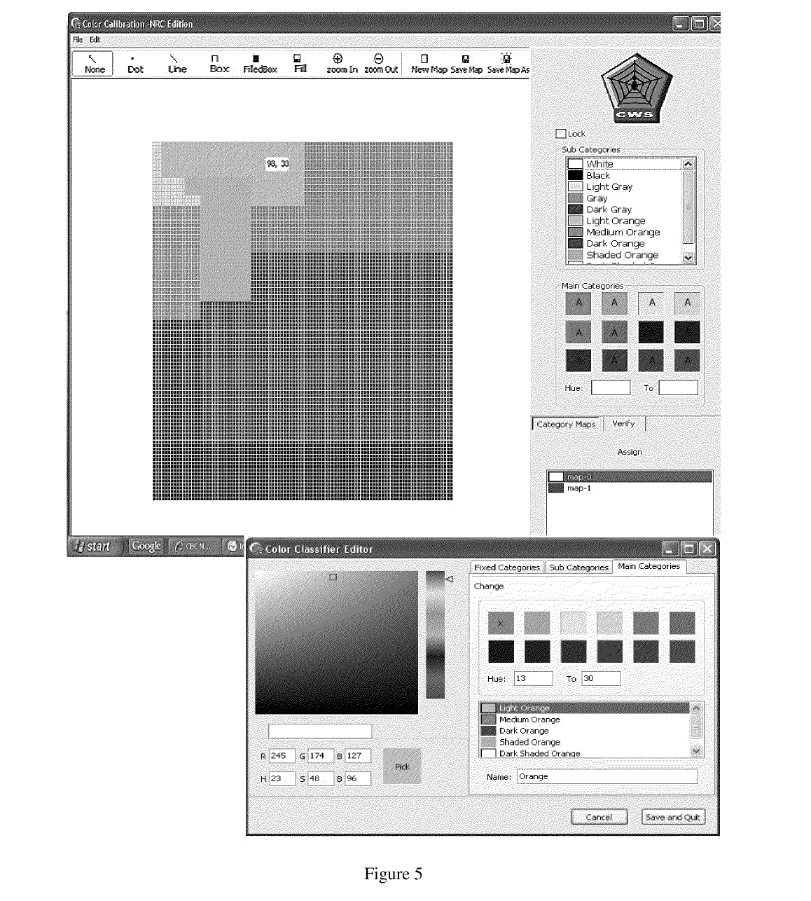

To address these issues, a calibration tool can be provided to the user, allowing the user to select new boundaries for both the categories in Table 1, and for the sub-categories associated with the color map of FIG. 2. An example of the interface of a tool is provided in FIG. 5.

The user is provided the ability to either numerically (for RBG or HSB values) or graphically select color categories, and the boundaries between them. A similar functionality can be provided for the fixed categories and the sub-categories. In one embodiment, the user is provided the ability to specify representative colors for each color and fixed category, and then is provided the ability to name each category with a user friendly name. The boundaries between the categories can be determined by the calibration tool, and adjusted by the user. The boundaries used to differentiate between the sub-categories can also be set graphically in any number of ways that would be apparent to those skilled in the art.

Refinements to the categories and sub-categories performed by the calibration tool can be directly provided to the segmentation tool, and used in the segmentation process as described above. A desired combination of fixed categories, main categories and sub-categories can also be saved as a color map and reused later.

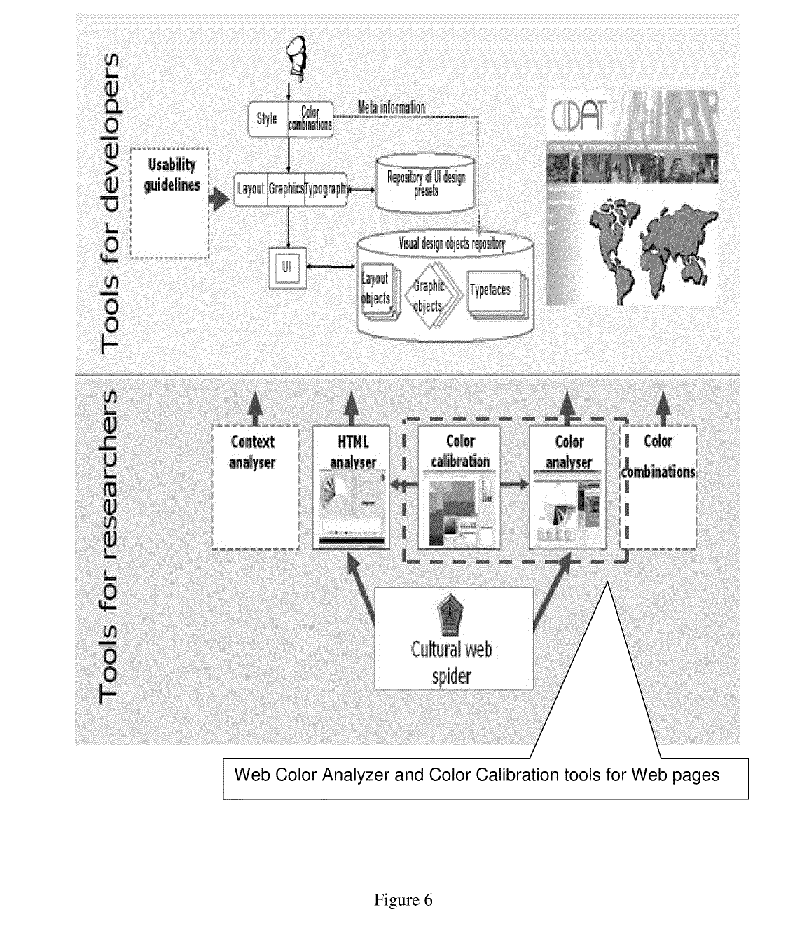

Uses of the above described invention, and details particular to a non-restrictive embodiment will now be discussed. If a user wishes to determine color preferences of websites aimed at a particular geographic region, a set of websites representative of the popular websites in the region can be selected. A software based implementation of the present invention, as illustrated in FIG. 6, can be used in conjunction with other elements outside the scope of the present invention. A cultural web spider (web crawler) is an example of an external tool that can be employed to generate a set grouping of URLs that are related to each other on the basis of geographic appeal or other demographic information. In one embodiment, the cultural web spider generates a list of highly ranked websites for a particular geographic domain using publicly accessible information available from search engine indices.

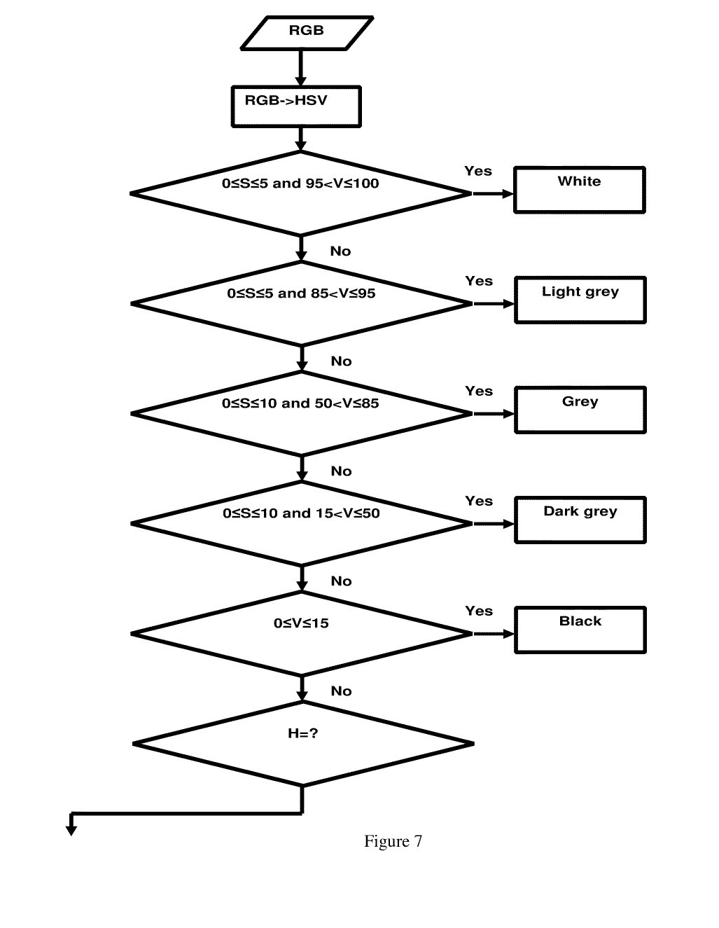

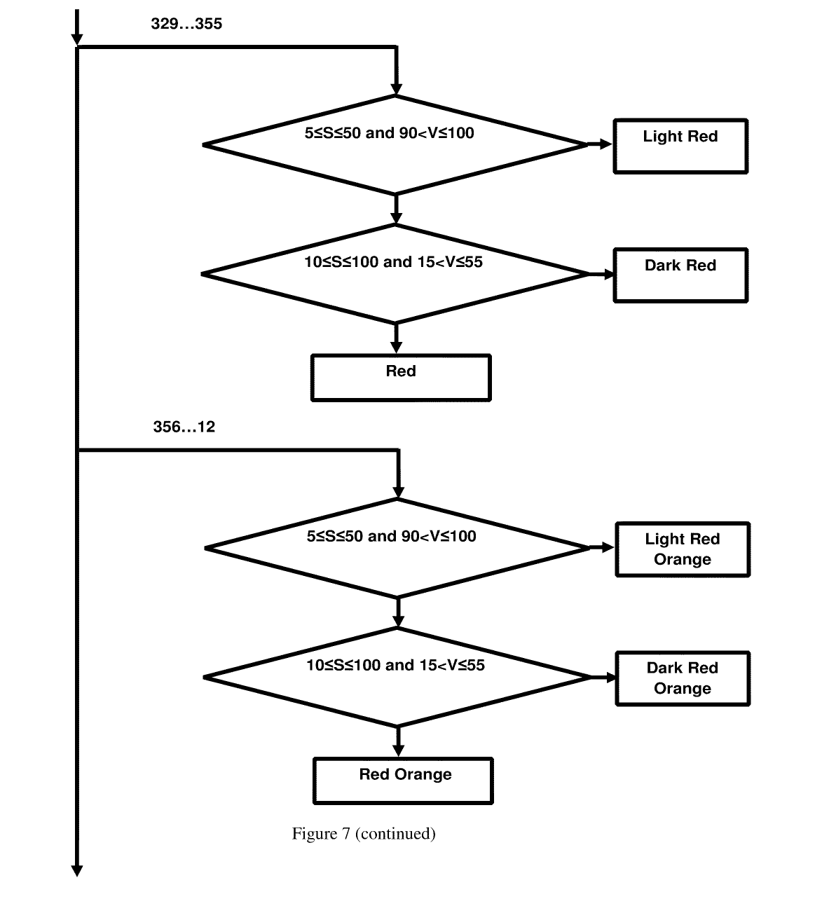

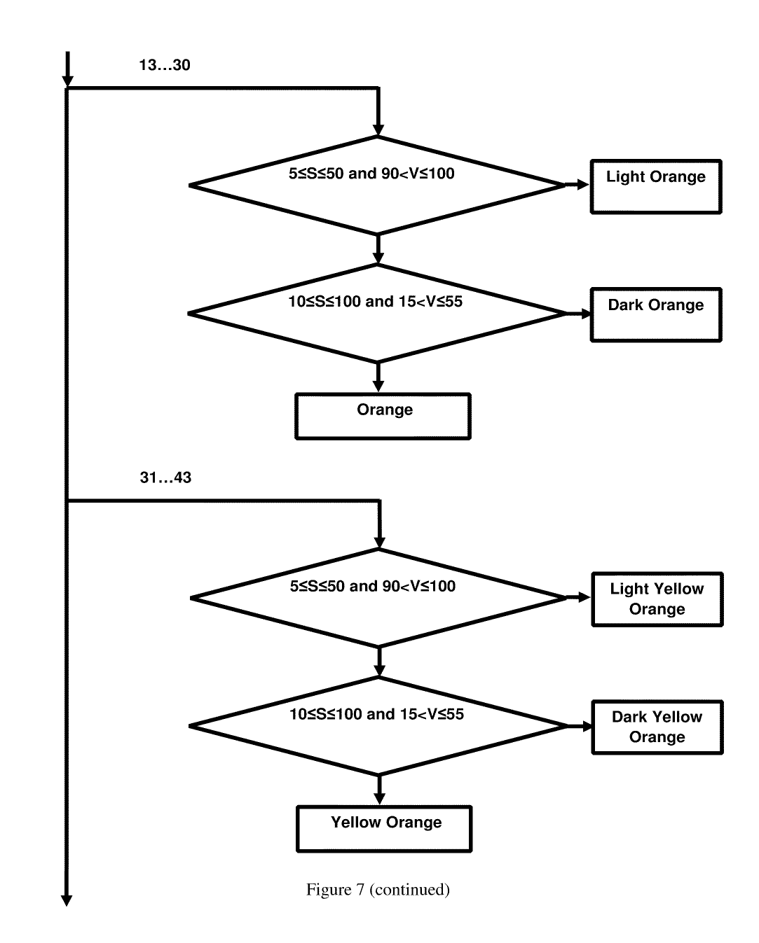

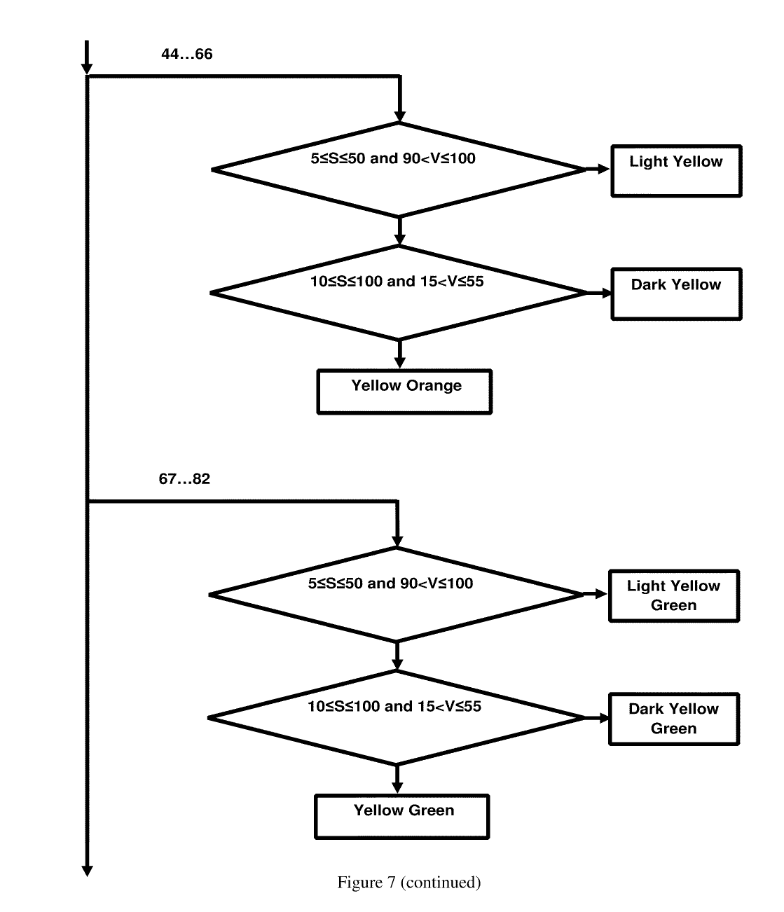

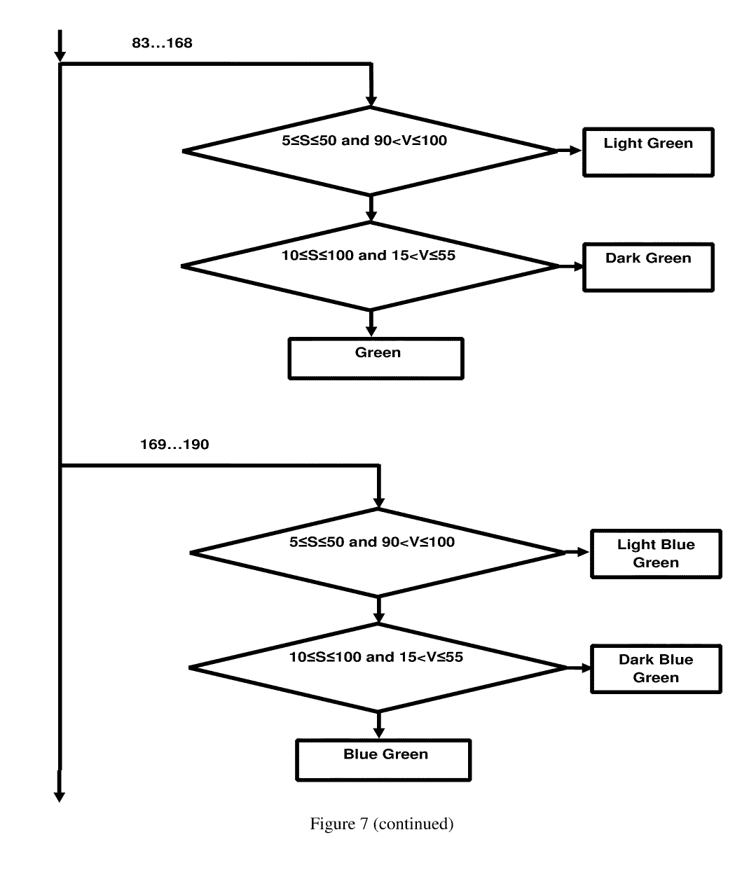

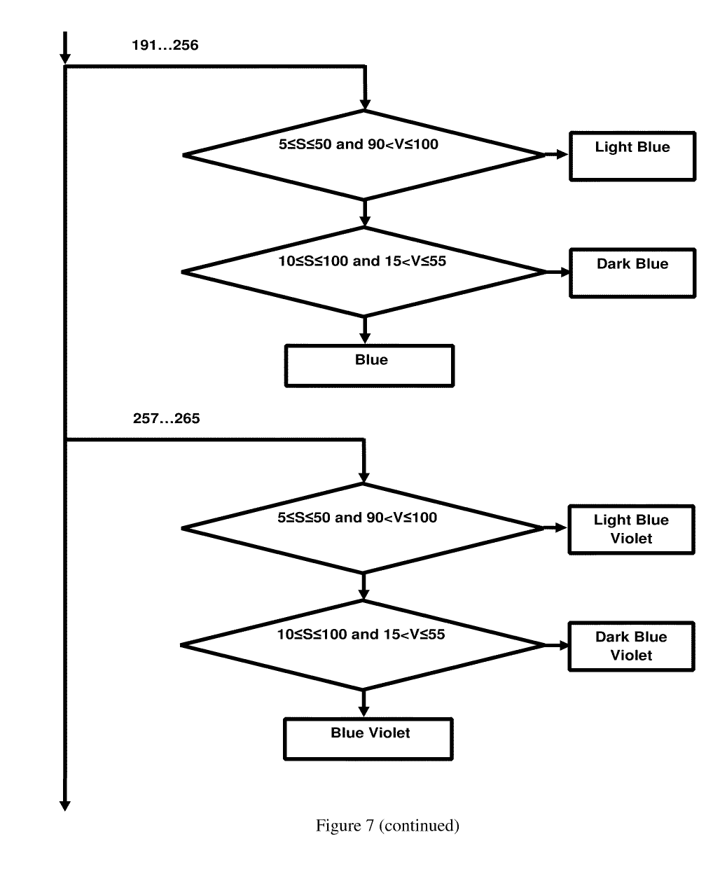

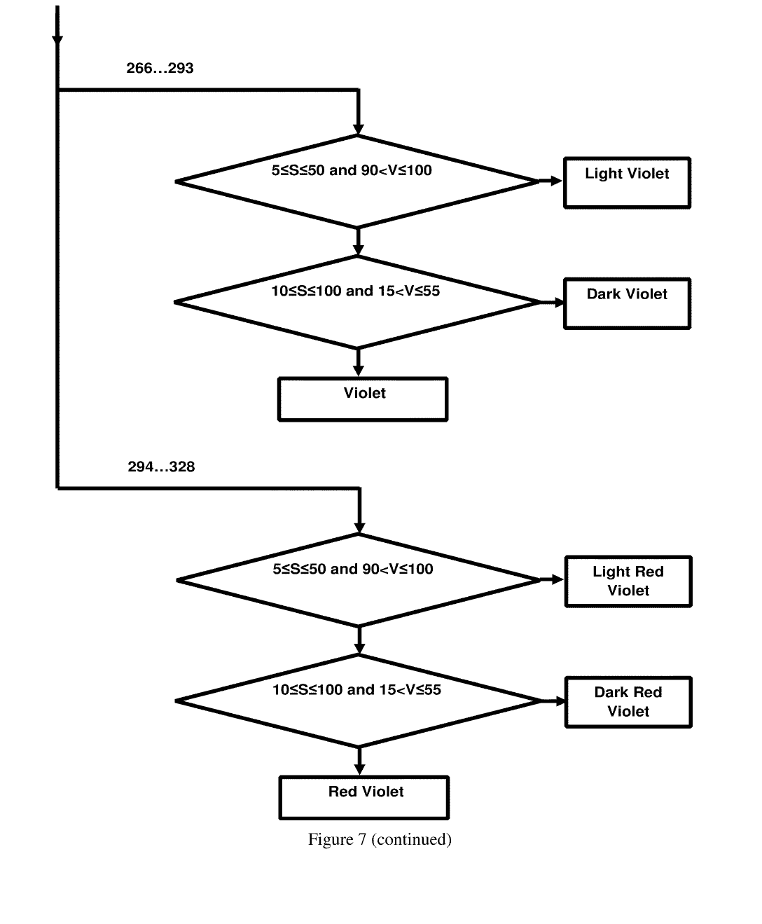

The color segmentation process, as described above, can be employed on a small set of pages to allow the user to verify that the segmentation boundary values are accurate using the before and after views as illustrated in FIG. 4. The user can then adjust the boundaries between segments to suit the distribution of colors in the small set of pages. After setting the color segmentation boundaries using the calibration tool of FIG. 5, the segmentation process can be run, without generating substitute images. An example of an expanded flowchart for use in the segmentation process is provided in FIG. 7. The segmentation process is performed on all the images, incrementing category and sub-category counts as appropriate.

At the conclusion of the segmentation process, the output values are used to generate a pie chart showing the user the breakdown of colors used on the set of pages. Whereas prior to the use of such a quantitative analysis tool, designers were required to research cultural implications of colors, designers can now select color families for use in designs based on a quantitative analysis. Without needing to understand why certain colors are frequently used by a cultural group, analysis of pages relevant to that cultural group will result in a designer being able to identify the colors that are frequently used.

It will be appreciated that the output values obtained at the conclusion of the segmentation process can be used to generate alternative forms of visualization and/or graphical representation.

One skilled in the art will appreciate that the color segmentation and quantitative analysis tools of the present invention can be used in many other areas.

As discuss further below, one such use is in medical imaging. Medical imaging often involves the production of colored images, with each selected color having a meaning, such as the intensity of the presence of a certain compound (such as a medical dye). The use of the present invention allows for a quantitative analysis of the various colors in the image to allow for a presentation of the amount of an image corresponding to a certain segment of colors.

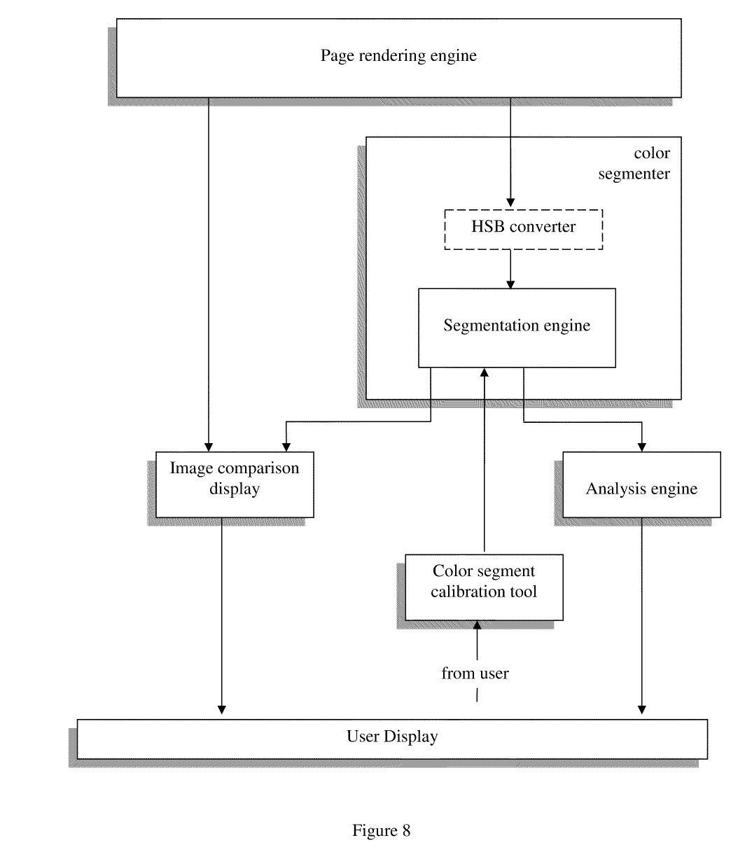

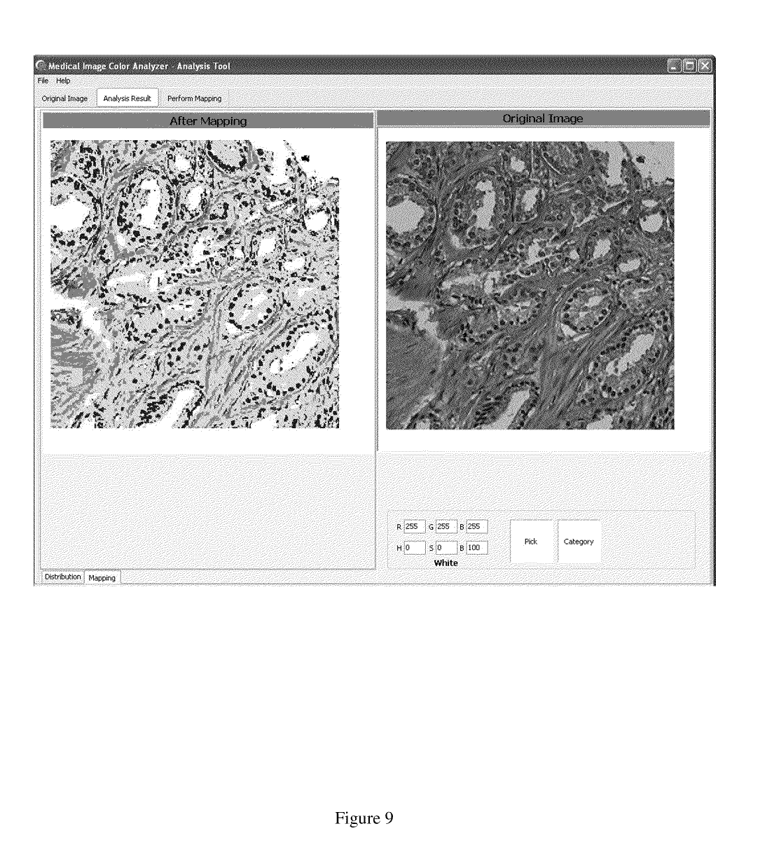

An exemplary system of the present invention is illustrated in FIG. 8. A page rendering engine provides images of rendered pages to the color segmenter of the present invention. The segmenter includes an HSB converter for converting non-HSB based images into HSB representations. The HSB representation of the image is then provided to the segmentation engine which uses the defined segmentation boundaries to assign categories to the pixels in the image. The segmented image can be displayed by the image comparison display alongside the original image allowing the user to review the result of the segmentation. In response to this data (or the graphical result of the analysis engine) the user can employ the color calibration tool to adjust the boundaries used by the segmentation engine. The output of the segmentation engine is also provided to the analysis engine which generates a quantitative analysis of the colors in segmented image for display to the user. The quantitative analysis can be displayed numerically or graphically as desired by the user.

Medical Image(s)

In accordance with another aspect of the invention, the system(s) and method(s) of the present invention as discussed above with respect to web page analysis are used in for the analysis of medical images.

In this embodiment, a rendering engine renders the medical image to either a stored graphic file (preferably using a standard file format such as Tagged Image File Format (TIFF), Joint Photographic Experts Group (JPEG), or a bitmap file) or to an input of a graphic analysis engine.

As described above, in the color segmentation process, the input image (the image generated from the rendering of the medical image) is converted to an HSB color model showing the color as an HSB triplet. This step can be skipped if the image is already provided as an HSB file.

As with the color assignment of HSB triplet values with respect to web-page images, a user can specify a custom color segmentation (e.g., choose from existing library of maps or create a new map) using a calibration tool and view the result of that map being applied for analysis of a particular image in a analysis/viewer window.

The system and method of the present application are useful to assist in medical imaging diagnostics. For example the systems and methods can be used in detecting different stages of prostate cancer by analyzing the histopathology interpretation of stained tissue sections. This is done through applying the color segmentation algorithm and color visualization tools that allow discriminating among the classes in the tissue based on color. Color maps created within the tool are saved and could be reused for analysis of similar images or identification of similar features. In addition, a set of maps could be created for a particular lighting condition (e.g. specific type of a microscope, endoscope, etc.) and applied by the end user or a group of end users in a consistent manner to ensure more accurate analysis.

In another example, the system and method of the present application are useful in medical image diagnosis where certain color regions are used to identify important features and/or a disease that is identifiable by a medical practitioner.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

The embodiments of the invention in which an exclusive property or privilege is claimed are defined as follows:

1. A method of analyzing color distribution in at least one image, comprising:
rendering said at least one image to generate an input image having at least one pixel; and
segmenting said at least one input image to a fixed category or a color category and subcategory, based on an HSB triplet value of said at least one pixel.

2. The method of claim 1, further comprising determining a distribution of said segmented at least one pixel in said fixed category or said color category and subcategory.

3. The method of claim 1, wherein said segmentation further comprises converting said at least one pixel to said HSB triplet value.

4. The method of claim 1, wherein said segmentation comprises locating said HSB triplet value in a color lookup table.

5. The method of claim 1, wherein said at least one image is a web browser image or medical image.

6. The method of claim 1, wherein the dimensions of said at least one image are defined as a pixel window.

7. The method of claim 1, wherein said rendering of said at least one image is carried out using an HTML rendering engine.

8. The method of claim 1, wherein said input image is a TIFF file, a JPEG file, a bitmap file or an input file.

9. The method of claim 1, further comprising adjusting the boundaries of said fixed category or said color category and subcategory.

10. The method of claim 9, wherein boundaries are set numerically or graphically.

11. A system for analyzing color distribution in at least one image, comprising:
a processor;
memory;
computer instructions stored in memory and executable by the processor for performing the functions of:
rendering said at least one image to generate an input image having at least one pixel; and
segmenting said at least one input image to a fixed category or a color category and subcategory, based on an HSB triplet value of said at least one pixel.

12. The system of claim 11, further comprising determining a distribution of said segmented at least one pixel in said fixed category or said color category and subcategory.

13. The system of claim 11, wherein said segmentation further comprises converting said at least one pixel to said HSB triplet value.

14. The system of claim 11, wherein said segmentation comprises locating said HSB triplet value in a color lookup table.

15. The system of claim 11, wherein said at least one image is a web browser image or medical image.

16. The system of claim 11, wherein the dimensions of said at least one image are defined as a pixel window.

17. The system of claim 11, wherein said rendering of said at least one image is carried out using an HTML rendering engine.

18. The system of claim 11, wherein said input image is a TIFF file, a JPEG file, a bitmap file or an input file.

19. The system of claim 11, further comprising adjusting the boundaries of said fixed category or said color category and subcategory.

20. The system of claim 19, wherein boundaries are set numerically or graphically.

21. A computer readable recording medium having recorded thereon a program for executing the method of any one of claims 1-10.
